(19) United States
(12) Patent Application Publication
(10) Pub. No.: US 2025/0198206 A1
(43) Pub. Date: Jun. 19, 2025

(54) ACTUATOR FOR MOTOR VEHICLE APPLICATIONS

(71) Applicant: KIEKERT AKTIENGESELLSCHAFT, Heiligenhaus (DE)

(72) Inventors: Jan ZEJDA, Chrudim (CZ); Udo ORZECH, Velbert (DE); Martin KREJCÍ, Zlunice (CZ)

(73) Assignee: KIEKERT AKTIENGESELLSCHAFT, Heiligenhaus (DE)

(21) Appl. No.: 18/846,394

(22) PCT Filed: Feb. 17, 2023
(86) PCT No.: PCT/DE2023/100132

§ 371 Date: Feb. 20, 2025

(30) Foreign Application Priority Data
Mar. 30, 2022 (DE) 10 2022 107 518.4

(51) Int. Cl. E05B 81/36; E05B 81/06; E05B 81/14; E05B 81/30

(52) U.S. Cl. CPC E05B 81/36; E05B 81/06; E05B 81/14; E05B 81/30

(57) ABSTRACT

The invention relates to an actuator for motor vehicle applications, in particular for a motor vehicle lock and preferably an actuator integrated in a motor vehicle door lock. In its basic construction, the actuator has an electric motor (4) and an actuating element (10) which is acted upon directly or indirectly by the electric motor (4) via a drive train (5 to 9). The drive train (5 to 9) is equipped with at least one first evoloid toothing (5, 6) and one second evoloid toothing (7, 8) which adjoin one another. Each evoloid toothing (5, 6; 7, 8) has: an evoloid pinion (5, 7) which can be rotated about an evoloid axle (5a, 7a); and an evoloid output wheel (6, 8) which meshes with the evoloid pinion and can be rotated in each case about a wheel axle (6a, 8a). According to the invention, the two evoloid toothings (5, 6; 7, 8) are positioned perpendicular relative to one another in such a way that the two evoloid axles (5a, 7a) are for the most part perpendicular relative to one another.

The invention relates to an actuator for motor vehicle applications, in particular a drive for a motor vehicle lock and preferably a drive integrated in a motor vehicle door lock, with an electric motor and with an actuating element which is acted upon directly or indirectly by the electric motor via a drive train, wherein the drive train is equipped with at least one first and one second evoloid toothing which adjoin one another, and wherein each evoloid toothing has an evoloid pinion which can be rotated about an evoloid axle and an evoloid output wheel which meshes with the evoloid pinion and can in each case be rotated about a wheel axle.

Actuators for motor vehicle applications are used in a variety of ways on and in a motor vehicle. For example, such actuators are used to adjust an outside mirror, adjust a seat, adjust headlights, operate window lifters in a window lift drive or to switch windshield wipers on or off. In addition, in principle, hinged elements such as a tailgate, a trunk lid, a motor vehicle door, an engine hood or the like can also be acted upon with the aid of such actuators.

In addition to these general motor vehicle applications for actuators, these actuators are particularly preferably used in connection with motor vehicle closing devices and are employed in practice. Such motor vehicle locking devices are usually motor vehicle locks and in particular motor vehicle door locks.

In this connection, the actuator or drive acts as an opening drive, for example, to ensure that a locking mechanism of the motor vehicle locking device is opened. To do this, the drive works on a pawl, for example, and lifts it from its locking engagement with the rotary latch. In addition, such drives are often also used as closing drives and ensure that the relevant locking mechanism is closed. This usually takes place from a previously established pre-latching position to a main latching position or an over-stroke position.

Closing drives are often designed separately from a motor vehicle locking device or a motor vehicle lock and are designed for this purpose as spindle/spindle nut gears, as described in the prior art according to DE 20 2008 007 719 U1. However, the design effort in this connection is great because, for example, both the actuator and the associated motor vehicle lock must have their own housing. In addition, a coupling and flexible connecting element in the form of, for example, a Bowden cable is required. Finally, there is often not enough space in a motor vehicle side door for the actuator on the one hand and the motor vehicle lock on the other hand.

For this reason, actuators with a compact design are preferred in practice because installation conditions are often cramped. This applies not only if the relevant actuator is to be placed inside a motor vehicle door in connection with a motor vehicle lock, but also in applications for seat adjustment, an outside mirror or even a headlight adjustment as well as in connection with a window lifter.

Since the aforementioned applications sometimes require strong actuating forces or high torques, multi-stage gears are often implemented, which are acted upon by means of the high-speed electric motor. As a result, slow adjusting movements with high torque can be realized on the output side of the gear. This is possible even if the electric motor—as is usual in motor vehicle applications—is operated with a low direct voltage and moderate electrical currents and consequently a relatively low electrical power.

For this purpose, the generic prior art according to DE 10 2017 125 819 A1 proposes an actuator which is equipped with an evoloid pinion on the output shaft of the electric motor, which also meshes with an evoloid output wheel with the direct realization of a first evoloid toothing at the input of the drive train. In addition, the drive train then has a second evoloid toothing.

Such evoloid toothings are typically characterized by high transmission ratios or reduction ratios, so that a high torque can be made available on the output side by using a small number of gear stages. This means that high speed reduction ratios of, for example, more than 5 to 1 or even more than 10 to 1 can usually be achieved at this point, if one assumes that the electric motor is on the input side and runs at high speed and takes into account that the actuating element provided on the output side of the drive train, in contrast, requires only small adjusting movements but with high torque.

The two evoloid toothings in the generic prior art according to DE 10 2017 125 819 A1 already ensure that a particularly compact design is achieved and at the same time high transmission ratios or reduction ratios are made available by using a single or at most two gear stages. The generic prior art according to DE 10 2008 054 398 A1 also shows comparable advantages.

In contrast to the first-mentioned publication DE 10 2017 125 819 A1, which represents the closest prior art, the drive mentioned secondarily (in DE 10 2008 054 398 A1) is mainly used in connection with the operation of a brake of the motor vehicle, so that in this connection, when using suitable materials, it is particularly important to be able to control any heat influence of the brake. For this reason, the individual gears—if at all—are produced from special plastics, for example polyphthalamide (PPA) or aromatic polyamide materials (PA). However, such plastics are particularly cost-intensive and are therefore not used in actuators for use in or in connection with motor vehicle locking devices, because they are produced in extremely large quantities.

The prior art has proven itself overall, but still offers room for further improvement. This is because both the closest teaching according to DE 10 2017 125 819 A1 and DE 10 2008 054 398 A1 is generally carried out in such a way that the two evoloid toothings adjoin one another in such a way that in each case the evoloid axle and the associated wheel axle are parallel to one another, so that although a somewhat nested arrangement is observed overall, the positioning of the individual output wheels one behind the other leads to a relatively voluminous structure. The invention as a whole seeks to remedy this.

The invention is based on the technical problem of further developing such an actuator for motor vehicle applications in such a way that a further improved use of space is observed compared to the prior art and consequently compactness is improved.

To solve this technical problem, a generic actuator for motor vehicle applications is characterized within the scope of the invention in that the two evoloid toothings are positioned perpendicular relative to one another, in such a way that the two evoloid axles are for the most part perpendicular relative to one another.

This means that within the scope of the invention, the two evoloid toothings continue to directly adjoin one another. However, the overall procedure is such that, in contrast to the prior art, the two evoloid toothings do not correspond to engagement surfaces that are aligned parallel to one another, but rather, according to the invention, the respective engagement surfaces of the two evoloid toothings are positioned perpendicular relative to one another, so that in this way the installation space can be reduced even more or less significantly compared to previous embodiments.

Within the scope of the invention and advantageously, the two evoloid toothings or their engagement surfaces are positioned predominantly perpendicular relative to one another, in such a way that the evoloid axle and the wheel axle of one of the two evoloid toothings are positioned perpendicular relative to one another. This means that at least one of the two evoloid toothings is designed in such a way that the evoloid axle of the evoloid pinion on the one hand and the wheel axle of the evoloid output wheel meshing with the evoloid pinion on the other hand enclose a predominantly vertical angle between them and are therefore positioned perpendicular relative to one another. As a result, the evoloid output wheel can be placed “on” the evoloid pinion. This means that the evoloid output wheel extends from the evoloid axle of the evoloid pinion in a virtually vertical extension above or below the evoloid axle and adjoins the evoloid pinion, so that the evoloid pinion and the evoloid output wheel can still come into contact with one another unchanged. For this purpose, each evoloid output wheel usually has a helical toothing, whereas the associated evoloid pinion is equipped with an evoloid toothing, as will be explained in more detail within the scope of the embodiment.

The procedure is usually such that the evoloid axle and the wheel axle of the first evoloid toothing are positioned for the most part perpendicular relative to one another. In contrast, the evoloid axle and the wheel axle of the second evoloid toothing are positioned predominantly parallel to one another. The relativization of the positions in the sense of “largely” or “predominantly” takes into account the fact that the associated gear wheels are mostly designed and assembled as plastic gears with limited manufacturing accuracy.

Since the two evoloid toothings (directly) adjoin one another, the design is also such that the wheel axle of the first evoloid toothing coincides with the evoloid axle of the second evoloid toothing. This is achieved and ensured within the scope of the invention in that the evoloid output wheel of the first evoloid toothing is also equipped with an evoloid pinion or this adjoins the evoloid output wheel in such a way that the wheel axle and the evoloid axle coincide. As a result, the evoloid axle and the wheel axle of the second evoloid toothing can be positioned predominantly parallel to one another.

In addition, the design is then further effected such that the evoloid axle of the first evoloid toothing and a drive axle of an output shaft of the electric motor coincide. As a result, the output shaft of the electric motor accommodates the evoloid pinion of the first evoloid toothing. Since, in addition, the evoloid axle and the wheel axle of the first evoloid toothing are positioned perpendicular relative to one another, according to an advantageous embodiment, the overall operation is such that the evoloid output wheel of the first evoloid toothing adjoins in a vertical extension above or below the output shaft of the electric motor as the evoloid axle of the first evoloid toothing with the evoloid pinion positioned thereon.

The evoloid output wheel of the second evoloid toothing is furthermore and advantageously equipped with an output pinion for driving a drive pawl as an actuating element. In this way, the two evoloid toothings in connection with the output pinion define the drive train as a whole, which, in a preferred variant, directly acts on the actuating element or the drive pawl as an actuating element. This direct action results from the fact that the output pinion of the drive train usually meshes with the drive pawl via a toothed segment. This means that the drive pawl advantageously engages with the relevant toothed segment in the output pinion. In addition, the drive pawl usually has a drive arm to act on a locking mechanism consisting substantially of a rotary latch and a pawl.

In addition to the described direct action of the actuating element or the drive pawl by means of the drive train, it is of course also possible in principle and within the scope of the invention for the actuating element to be acted upon indirectly. In this case, the output pinion at the end of the drive train may work on another pinion, for example, which then in turn acts on the drive pawl. Of course, another connecting means (other than the gear described above) can also be interposed between the output pinion and the drive pawl or, in general, the actuating element in order to be able to indirectly act on the actuating element with the aid of the drive train.

In order to achieve a design that is both cost-effective and durable, the output pinion and the drive pawl in each case are usually made of metal, for example steel. As a result, repeated adjustment processes over long time scales can also be realized. In contrast, the evoloid pinions and the evoloid output wheels are usually at least partially designed as plastic gears. In most cases, the evoloid pinions and evoloid output wheels are all plastic gears. These can be manufactured particularly cost-effectively from thermoplastics, for example, possibly with embedded glass or plastic fibers. In addition, such plastic gears are lightweight.

The invention also relates to a motor vehicle lock and in particular a motor vehicle door lock, which is equipped with a locking mechanism consisting substantially of a rotary latch and a pawl. In addition, the motor vehicle lock and in particular the motor vehicle door lock in question also has an actuator for the locking mechanism. The actuator can work as an opening drive on the pawl by lifting the pawl from its locking engagement with the rotary latch. The rotary latch can then be opened with spring support. However, it is also possible for the actuator to work as a closing drive on the rotary latch. In this case, the closing drive ensures that the rotary latch, which has been manually moved into a pre-latching position, for example, is closed with the help of the actuating element or the drive pawl in the example case, to the main latching position or even an over-stroke position. In principle, however, the actuator can also work both as an opening drive on the pawl and as a closing drive on the rotary latch.

In all of these cases, the actuator described above and according to the invention is integrated in the relevant motor vehicle lock and in particular motor vehicle door lock. This additionally means that the actuator in question is accommodated together with the locking mechanism and, if applicable, other lock components in a common lock housing and in particular a door lock housing or generally a common housing. The housing in question is also typically made of plastics for weight and cost reasons and is usually sealed against moisture and dust.

In this way, an actuator for motor vehicle applications is described which is particularly suitable for use with motor vehicle locking devices in general and motor vehicle locks in particular, and preferably motor vehicle door locks. In this connection, the actuator in question can advantageously perform the function of an opening drive and/or closing drive. For this purpose, the drive in question is typically integrated in the housing of the motor vehicle locking device in general or of the motor vehicle lock, and preferably of the motor vehicle door lock.

All of this is possible and can be implemented because, on the one hand, a drive train with ultimately only two or three gear stages from the two evoloid toothings and the output pinion on the output side are used, which engages in the drive pawl as an actuating element. Nevertheless, this and other aspects make it possible to achieve transmission or reduction ratios that can assume comparable values to those in the generic prior art according to DE 10 2017 125 819 A1, i.e., for example, values of more than 50 to 1 and even more than 80 to 1 for the entire gear. As a result, high torques or forces are available on the actuating element.

At the same time, the actuator according to the invention is characterized by a particularly compact design, which is substantially due to the fact that the two evoloid toothings are positioned perpendicular relative to one another, i.e. their respective engagement surfaces are positioned perpendicular relative to one another, as has been described in detail above. As a result, in particular the evoloid output wheel of the first evoloid toothing can be placed in a quasi-perpendicular projection above the associated evoloid pinion positioned on the output shaft of the electric motor.

In this way, no additional lateral installation space is required for the relevant evoloid output wheel and the evoloid output wheel of the second evoloid toothing can be placed directly adjacent to the electric motor, as will be described in more detail below in the embodiment. In any case, these considerations make it clear that the invention leads to an even smaller installation volume compared to the prior art, which, in connection with the high transmission or reduction ratio, the low weight and at the same time the low costs, offers particular advantages.

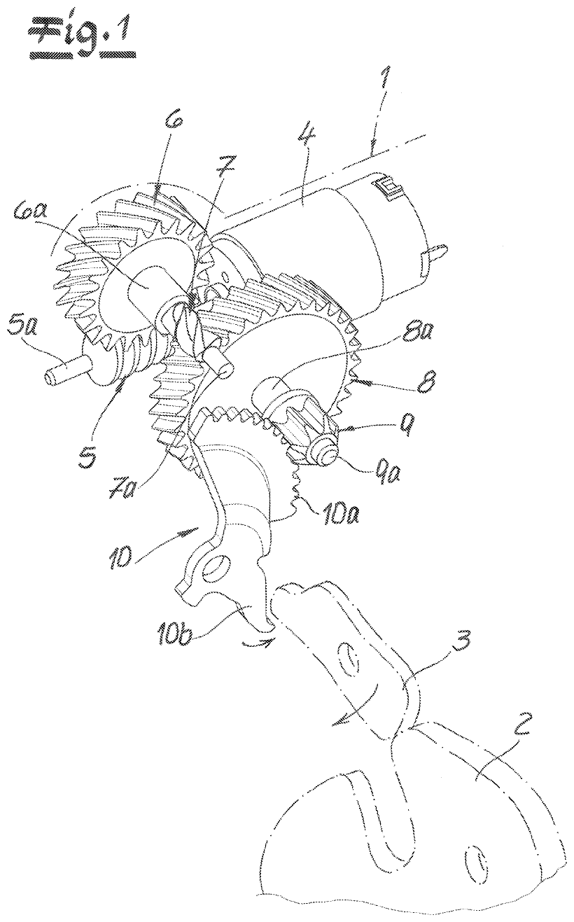

The invention is explained in greater detail below with reference to a drawing which shows only one embodiment. The sole FIG. 1 shows the actuator according to the invention for motor vehicle applications in perspective.

FIG. 1 shows an actuator for motor vehicle applications. The actuator in question is generally used as a drive in connection with a motor vehicle lock and preferably a motor vehicle door lock. For this purpose, the actuator is integrated in a housing 1 of the relevant motor vehicle lock, which is only indicated in FIG. 1. The housing 1 is made of plastics. It can be seen that the housing 1 not only accommodates the actuator, which will be described in more detail below, but also a locking mechanism 2, 3 consisting of a rotary latch 2 and a pawl 3 with conventional functionality. In this way, the actuator can work, for example, as a closing drive on the rotary latch 2, which is not shown in detail, but functions in a manner comparable to the prior art according to DE 20 2008 007 719 U1. In contrast, a variant is shown in which the actuator acts as an opening drive and for this purpose lifts the pawl 3 from its locking engagement with the rotary latch 2, as indicated by corresponding arrows in FIG. 1.

The actuator, which is accommodated in the housing 1 together with the locking mechanism 2, 3, is equipped in its basic construction with an electric motor 4 and a drive train 5, 6, 7, 8, 9. According to the embodiment, the drive train 5 to 9 works directly on an actuating element 10, which according to the embodiment is designed as a drive pawl 10. With the aid of the drive pawl 10 and when the actuator is designed as an opening drive of the motor vehicle lock shown, the pawl 3 can be pivoted about its axle in the clockwise direction indicated in FIG. 1, so that the pawl 3 releases the previously caught rotary latch 2 (in the closed position shown), which in turn pivots open with the aid of a spring and releases a locking bolt (not shown). The same applies to an associated motor vehicle door.

The drive train 5 to 9 is equipped in detail with at least two adjoining evoloid toothings 5, 6; 7, 8. A first evoloid toothing 5, 6 and a second evoloid toothing 7, 8 are implemented. On the output side of the drive train 5 to 9, an output pinion 9 can be seen, with the aid of which the drive pawl 10 is acted upon as an actuating element. For this purpose, the drive pawl 10 is equipped with a toothed segment 10a, which engages in the output pinion 9 and meshes with the drive pawl. In addition, the drive pawl 10 also has a drive arm 10b, with the aid of which the locking mechanism 2, 3 is acted upon and, specifically and according to the embodiment, the locking pawl 3 is lifted from its locking engagement with the rotary latch 2—as described.

The two evoloid toothings 5, 6; 7, 8 directly adjoin one another. In addition, each evoloid toothing 5, 6; 7, 8 has a respective evoloid pinion 5 or 7, which is designed to be rotatable about an associated evoloid axle 5a, 7a. An associated evoloid output wheel 6, 8 meshes with the relevant evoloid pinion 5, 7 and is designed to be rotatable about an associated wheel axle 6a, 8a. It can be seen that the output pinion 9 provided on the output side of the drive train 5 to 9 is also equipped with an axle 9a which, according to the embodiment, coincides with the wheel axle 8a of the evoloid output wheel 8 of the second evoloid toothing 7, 8.

According to the invention, the design is such that the two evoloid toothings 5, 6; 7, 8 are positioned perpendicular relative to one another. The vertical arrangement is due to the fact that the two evoloid toothings 5, 6; 7, 8 have a positioning of their respective evoloid axles 5a; 7a, which are perpendicular relative to one another. The design within the scope of the embodiment is such that the evoloid axle 5a of the first evoloid toothing 5, 6 and a drive axle of an output shaft of the electric motor 4 coincide. The evoloid pinion 5 of the first evoloid toothing 5, 6 is positioned on the relevant output shaft of the electric motor 4.

Furthermore, since the evoloid axle 5a of the evoloid pinion 5 and the wheel axle 6a of the evoloid output wheel 6 of the first evoloid toothing 5, 6 are positioned perpendicular relative to one another, the evoloid output wheel 6 can be positioned “on” the evoloid pinion 5 in a quasi-vertical projection or vertical extension of the output shaft of the electric motor 4 and consequently the evoloid axle 5a of the evoloid pinion 5 of the first evoloid toothing 5, 6. As a result, the evoloid output wheel 6 of the first evoloid toothing 5, 6 requires practically no lateral installation space and at least partially covers the electric motor 4 with its cylindrical housing when viewed from the front.

In contrast, the evoloid axle 7a and the wheel axle 8a of the second evoloid toothing 7, 8 are positioned parallel to one another. In addition, the design is such that the wheel axle 6a of the evoloid output wheel 6 of the first evoloid toothing 5, 6 coincides with the evoloid axle 7a of the evoloid pinion 7 of the second evoloid toothing 7, 8. As a result, the evoloid output wheel 8 meshing with the evoloid pinion 7 can be positioned directly adjacent to the electric motor 4. The evoloid output wheel 8 of the second evoloid toothing 7, 8 is now coupled to the output pinion 9 in a rotationally fixed manner. For this purpose, the relevant evoloid output wheel 8 on the one hand and the output pinion 9 on the other hand have a common axle 8a, 9a.

Each evoloid toothing 5, 6 and 6, 7 is equipped in each case with a helical evoloid toothing with a large transmission ratio. In addition, according to the embodiment, both evoloid pinions 5, 7 along with the two evoloid output wheels 6, 8 are in each case designed as plastic gears.

In this way, simple production with a high level of smoothness is observed.

In contrast, the output pinion 9 along with the actuating element 10 or the drive pawl 10 are usually made of metal and in particular steel. The output pinion 9 can be a cold-formed pinion, whereas the drive pawl 10 can be designed as a combined stamped/bent part.

With the aid of the actuator shown, reduction ratios for the electric motor 4 of more than 50 to 1 and even 80 to 1 and more can be realized and implemented, so that in the end and on the drive arm 10b of the drive pawl 10, sufficient force or a sufficiently high torque is available to be able to safely lift the pawl 3 from its locking engagement relative to the rotary latch 2 in the example case.

### LIST OF REFERENCE SIGNS

Housing 1
Rotary latch 2
Locking mechanism 2, 3
Pawl 3
Electric motor 4
Evoloid pinion 5, 7
Evoloid axle 5a, 7a
Wheel axle 6a, 8a
Evoloid output wheel 6, 8
Evoloid toothings 5, 6, 7, 8
Drive train 5, 6, 7, 8, 9
Output pinion 9
Axle 8a, 9a
Actuating element 10
Drive pawl 10
Toothed segment 10a
Drive arm 10b

1. An actuator for motor vehicle applications comprising:
an electric motor,
a drive train, and
an actuating element which is acted upon directly or indirectly by the electric motor via the drive train,
wherein the drive train is equipped with a first evoloid toothing and one second evoloid toothing which adjoin one another, and
wherein each of the first and second evoloid toothing has an evoloid pinion which is rotated about an evoloid axle, and an evoloid output wheel which meshes with the evoloid pinion and is rotated about a wheel axle, and
wherein the first and second evoloid toothings are positioned perpendicular relative to one another in such a way that the evoloid axles are perpendicular relative to one another.

2. The actuator according to claim 1, wherein the evoloid axle and the wheel axle of one of the first or second evoloid toothings are positioned perpendicular relative to one another.

3. The actuator according to claim 2, wherein the evoloid axle and the wheel axle of the first evoloid toothing are positioned perpendicular relative to one another.

4. The actuator according to claim 1, wherein the evoloid axle of the first evoloid toothing and a drive axle of an output shaft of the electric motor coincide.

5. The actuator according to claim 1, wherein the wheel axle of the first evoloid toothing coincides with the evoloid axle of the second evoloid toothing.

6. The actuator according to claim 1, wherein the evoloid axle and the wheel axle of the second evoloid toothing are positioned parallel to one another.

7. The actuator according to claim 1, further comprising a drive pawl, wherein the drive train is equipped with an output pinion for driving the drive pawl as an actuating element.

8. The actuator according to claim 7, wherein the drive pawl engages with a toothed segment in the output pinion and has a drive arm for acting on a locking mechanism including a rotary latch and a pawl.

9. The actuator according to claim 7, wherein the output pinion and the drive pawl are made of metal, and the evoloid pinions and the evoloid output wheels are at least partially designed as plastic gears.

10. A motor vehicle lock comprising:
a locking mechanism including a rotary latch and a pawl,
a common housing, and
an actuator according to claim 1 for the locking mechanism which works as an opening drive on the pawl and/or as a closing drive on the rotary latch, and the actuator is accommodated together with the locking mechanism in the common housing.

11. The actuator according to claim 7, wherein the output pinion is provided on the output wheel of the second evoloid toothing.

12. The actuator according to claim 7, wherein the output pinion includes a pinion axle that coincides with the wheel axle of the second evoloid toothing.

13. The actuator according to claim 7, further comprising a second pinion, and the output pinion acts on the drive pawl indirectly via the second pinion.
